(19) United States
(12) Patent Application Publication
(10) Pub. No.: US 2025/0039969 A1
(43) Pub. Date: Jan. 30, 2025

(54) COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Jianfei CAO, Dongguan (CN); Xin YOU, Dongguan (CN)

(21) Appl. No.: 18/913,527

(22) Filed: Oct. 11, 2024

Related U.S. Application Data
(63) Continuation of application No. PCT/CN2022/103968, filed on Jul. 5, 2022.

(51) Int. Cl. H04W 76/19; H04L 5/00; H04W 16/28; H04W 72/231; H04W 76/20

(52) U.S. Cl. CPC H04W 76/19; H04L 5/0051; H04L 5/0053; H04W 16/28; H04W 72/231; H04W 76/20

(57) ABSTRACT

A communications method and a communications apparatus are provided, and the method includes: receiving, by a terminal device, a first beam failure recovery acknowledgement from a network device, where the first beam failure recovery acknowledgement is used to approve a beam failure recovery request for an i-th transmission reception point (TRP) of M TRPs, the terminal device is configured and/or indicated with a unified transmission configuration indication (TCI) state, M is a positive integer greater than or equal to 1, and i is a positive integer less than or equal to M; and performing, by the terminal device, beam failure recovery on the i-th TRP.

This application is a continuation of International Application No. PCT/CN2022/103968, filed on Jul. 5, 2022, the disclosure of which is hereby incorporated by reference in its entirety.

### TECHNICAL FIELD

This application relates to the field of communications technologies, and more specifically, to a communication method and a communications apparatus.

### BACKGROUND

With development of communications technologies, a unified transmission configuration indication (unified TCI) state is introduced in some communications systems, so as to implement uplink/downlink unified beam indication, unified beam transmission, and the like. However, it is not known how a terminal device that is configured and/or indicated with a unified TCI state performs beam failure recovery (BFR) in a multi-TRP (multiple transmission reception point) scenario.

### SUMMARY

Embodiments of this application provide a communications method and a communications apparatus. The following describes the aspects involved in the embodiments of this application.

According to a first aspect, a communications method is provided, including: receiving, by a terminal device, a first beam failure recovery acknowledgement from a network device, where the first beam failure recovery acknowledgement is used to approve a beam failure recovery request for an i-th transmission reception point (TRP) of M TRPs, the terminal device is configured and/or indicated with a unified transmission configuration indication (TCI) state, M is a positive integer greater than or equal to 1, and i is a positive integer less than or equal to M; and performing, by the terminal device, beam failure recovery on the i-th TRP.

According to a second aspect, a communications method is provided, including: sending, by a network device, a first beam failure recovery acknowledgement to a terminal device, where the first beam failure recovery acknowledgement is used to approve a beam failure recovery request for an i-th transmission reception point (TRP) of M TRPs, the terminal device is configured and/or indicated with a unified transmission configuration indication (TCI) state, M is a positive integer greater than or equal to 1, and i is a positive integer less than or equal to M.

According to a third aspect, a communications apparatus is provided, including: A receiving unit, configured to receive a first beam failure recovery acknowledgement from a network device, where the first beam failure recovery acknowledgement is used to approve a beam failure recovery request for an i-th transmission reception point (TRP) of M TRPs, the apparatus is configured and/or indicated with a unified transmission configuration indication (TCI) state, M is a positive integer greater than or equal to 1, and i is a positive integer less than or equal to M; and a recovering unit, configured to perform beam failure recovery on the i-th TRP.

According to a fourth aspect, a communications apparatus is provided, including: a sending unit, configured to send a first beam failure recovery acknowledgement to a terminal device, where the first beam failure recovery acknowledgement is used to approve a beam failure recovery request for an i-th transmission reception point (TRP) of M TRPs, the terminal device is configured and/or indicated with a unified transmission configuration indication (TCI) state, Mis a positive integer greater than or equal to 1, and i is a positive integer less than or equal to M.

According to a fifth aspect, a communications apparatus is provided, including a memory, a transceiver, and a processor, where the memory is configured to store a program, the processor is configured to transmit or receive data by using the transceiver, and the processor is configured to invoke the program in the memory, to cause the communications apparatus to perform the method according to the first aspect.

According to a sixth aspect, a communications apparatus is provided, including a memory, a transceiver, and a processor, where the memory is configured to store a program, the processor is configured to transmit or receive data by using the transceiver, and the processor is configured to invoke the program in the memory, to cause the communications apparatus to perform the method according to the second aspect.

According to a seventh aspect, a communications apparatus is provided, including a processor, configured to invoke a program from a memory, to cause the communications apparatus to perform the method according to the first aspect.

According to an eighth aspect, a communications apparatus is provided, including a processor, configured to invoke a program from a memory, to cause the communications apparatus to perform the method according to the second aspect.

According to a ninth aspect, a chip is provided, including a processor, configured to invoke a program from a memory, to cause a device installed with the chip to perform the method according to the first aspect.

According to a tenth aspect, a chip is provided, including a processor, configured to invoke a program from a memory, to cause a device installed with the chip to perform the method according to the second aspect.

According to an eleventh aspect, a computer readable storage medium is provided, storing a program, where the program causes a computer to perform the method according to the first aspect.

According to a twelfth aspect, a computer readable storage medium is provided, storing a program, where the program causes a computer to perform the method according to the second aspect.

According to a thirteenth aspect, a computer program product is provided, including a program, where the program causes a computer to perform the method according to the first aspect.

According to a fourteenth aspect, a computer program product is provided, including a program, where the program causes a computer to perform the method according to the second aspect.

According to a fifteenth aspect, a computer program is provided, where the computer program causes a computer to perform the method according to the first aspect.

According to a sixteenth aspect, a computer program is provided, where the computer program causes a computer to perform the method according to the second aspect.

### BRIEF DESCRIPTION OF DRAWINGS

FIG. 1 is an example diagram of a wireless communications system to which embodiments of this application are applicable.

FIG. 2 is a schematic diagram of a beam failure recovery mechanism according to an embodiment of this application.

FIG. 3 is a schematic structural diagram of a BFR MAC CE according to an embodiment of this application.

FIG. 4 is a schematic diagram of an intra-cell multi-spatial filter and an inter-cell multi-spatial filter according to an embodiment of this application.

FIG. 5 is a schematic flowchart of a communication method according to an embodiment of this application.

FIG. 6 is a schematic diagram of multi-TRP beam failure recovery based on M-DCI scheduling according to an embodiment of this application.

FIG. 7 is a schematic diagram of a relationship between search space sets and CORESETs according to an embodiment of this application.

FIG. 8 is a schematic structural diagram of a communications apparatus according to an embodiment of this application.

FIG. 9 is a schematic structural diagram of a communications apparatus according to another embodiment of this application.

FIG. 10 is a schematic structural diagram of an apparatus according to an embodiment of this application.

### DESCRIPTION OF EMBODIMENTS

The technical solutions in the application are described below with reference to the accompanying drawings.

FIG. 1 shows a wireless communication system 100 to which an embodiment of this application is applied. The wireless communications system 100 may include a network device 110 and a user equipment (UE) 120. The network device 110 may communicate with the UE 120. The network device 110 may provide communication coverage for a specific geographic area, and may communicate with a UE 120 within the coverage area. The UE 120 may access a network (for example, a wireless network) via the network device 110.

FIG. 1 exemplarily shows one network device and two UEs. Optionally, the wireless communications system 100 may include a plurality of network devices, and another quantity of terminal devices may be included within a coverage range of each network device, which is not limited in embodiments of this application. Optionally, the wireless communication system 100 may further include another network entity such as a network controller or a mobility management entity, which is not limited in embodiments of this application.

It should be understood that the technical solutions of embodiments of this application may be applied to various communication systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communication system, such as a 6th generation mobile communication system or a satellite communication system.

The UE in embodiments of this application may also be referred to as a terminal device, an access terminal, a user unit, a user station, a mobile site, a mobile station (mobile station, MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be used to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) that connects the UE to a wireless network. The base station may broadly cover various names in the following, or may be replaced with the following names: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

In some embodiments, the network device may be fixed or mobile. For example, a helicopter or an unmanned aerial vehicle may be configured to function as a mobile network device, and one or more cells may move depending on a location of the mobile network device. In other examples, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or vehicle-mounted, may be deployed on a water surface, or may be deployed on a plane, a balloon, or a satellite in the air. In embodiments of this application, the network device and a scenario in which the network device is located in embodiments of this application are not limited.

It should also be understood that all or some of functions of the network device and the UE in this application may also be implemented by software functions running on hardware, or by virtualization functions instantiated on a platform (for example, a cloud platform).

Currently, some communications systems may support beam failure recovery (BFR) mechanisms in multiple different scenarios. For example, some communications systems (e.g., release 15 (R15) of the NR system) may support a beam failure recovery mechanism of a primary cell (PCell) or a primary secondary cell (PSCell), some communications systems (e.g., R16 of the NR system) may support a beam failure recovery mechanism of a secondary cell (SCell), and some communications systems, such as R17 of the NR system, may support a beam failure recovery mechanism of a special cell (SpCell) or a SCell transmission reception point specific (TRP-specific) beam failure recovery mechanism.

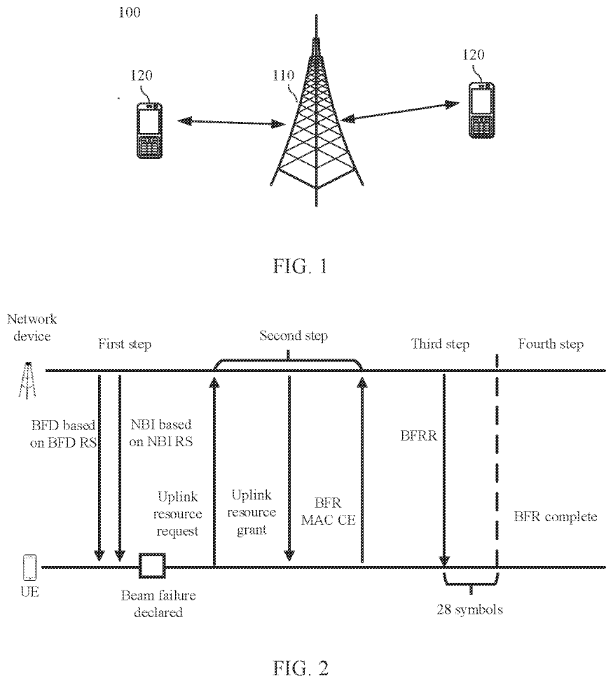

This embodiment of this application mainly relates to the TRP-specific beam failure recovery. The following describes a TRP-specific beam failure recovery mechanism with reference to FIG. 2.

The first step includes TRP-specific beam failure detection (BFD) based on a beam failure detection reference signal (BFD RS) and TRP-specific new beam identification (NBI) based on a new beam discovery reference signal (NBI RS). Each TRP is configured with a BFD RS Set and a NBI RS Set, where the BFD RS Set and the NBI RS Set are in a one-to-one correspondence. The BFD RS may include a periodic channel state information-reference signal (CSI-RS), and the NBI RS may include a synchronization signal and PBCH block (SSB) or a CSI-RS. After the first step, the UE may further make a beam failure declared.

The second step includes reporting a beam failure (BFRQ). After a beam failure occurs on one TRP, the UE needs to use an uplink resource to carry a media access control control element carrying beam failure request (BFR MAC CE) used to carry beam failure recovery to notify the network device of a beam failure status of the TRP. The uplink resource may be from resources requested by a PUCCH-scheduling request (PUCCH-SR) carrying a scheduling request and sent by the UE, or may be a physical uplink shared channel (PUSCH) resource of another use. In addition, the BFR MAC CE may also be inserted in a random access message 3 (Msg 3) or a message A (Msg A) (that is, sent by the Msg 3 or the Msg A).

The third step includes responding to a beam failure recovery (BFRR). After receiving the BFRQ sent by the UE, if the network device approves the TRP-specific beam failure recovery request of the UE, the network device provides the UE with an acknowledgment message (for example, a beam failure recovery acknowledgement), that is, approves that the UE can automatically recover a spatial filter of a specific channel under the TRP on which the beam failure occurs.

The fourth step includes that after 28 symbols or two timeslots after receiving the BFRR, the UE performs beam failure recovery. The UE may further recover an uplink power control parameter corresponding to the spatial filter.

It should be noted that in this embodiment of this application, the spatial filter may also be referred to as a beam. For ease of understanding, they are collectively referred to as a spatial filter in this embodiment of this application.

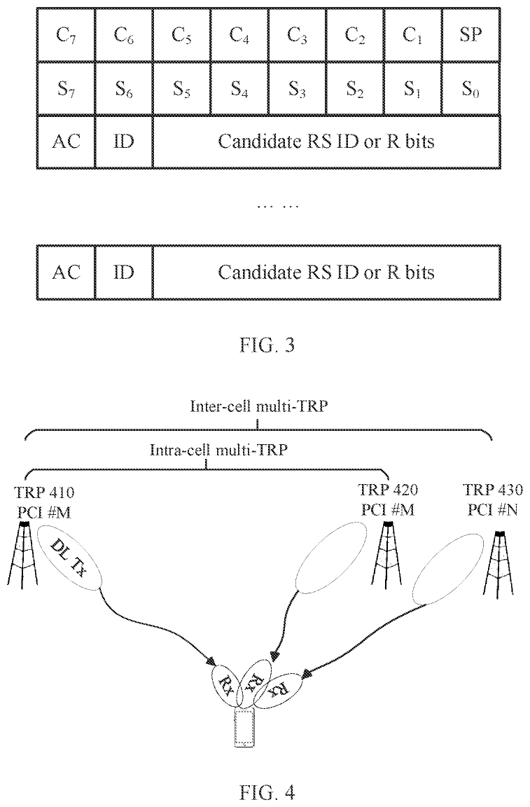

The TRP-specific beam failure recovery mechanism in FIG. 2 may be applicable to intra-cell and inter-cell multi-TRP operations. A format of the BFR MAC CE may be as shown in FIG. 3, where SP represents a beam failure detection on a special cell (SpCell) of a media access control (MAC) entity, Cm represents a beam failure detection on a secondary cell (SCell) whose identifier is ServCellIndex m, Sn represents whether two beam failure detection reference signals (BFD-RS) sets are configured on an n-th serving cell, AC represents that the byte includes a candidate reference signal (candidate RS) identifier (ID) field, ID represents an identifier of the BFD-RS set, and the candidate RS identifier (ID) may refer to a qnew (qnew may include qnew0 and/or qnew1) in the following embodiment. M, n, and R are all integers.

With continuous development of communications technologies, a unified transmission configuration indication (unified TCI) state is introduced in some communications systems. The unified TCI state may indicate a quasi co-location (QCL) relationship between different reference signals. For example, the UE may obtain, from a received CSI-RS, how to receive a reference signal that has not been transmitted, for example, a QCL relationship between a physical downlink control channel (PDCCH) demodulation reference signal (DMRS) and a physical downlink shared channel PDSCH) DMRS. This QCL relationship mainly works in a millimeter-wave frequency band (for example, a FR2 frequency band), and is mainly used to indicate a spatial filter.

The term “unified” in the unified TCI state has many levels of meanings. The meaning of a first level of “unified” lies in that the state unifies the uplink and downlink beam indication mechanisms. For example, in the NR system of R15 or R16, the TCI state is only used for downlink spatial filter indication, and uplink spatial filter indication uses spatial relation information-based signaling. The meaning of a second level of “unified” lies in unifying spatial filters between different channels. The unified TCI may include a joint transmission configuration indication (joint TCI) state and separate transmission configuration indication (separate TCI) states, and the separate TCI states may include a downlink transmission configuration indication (DL TCI) state and an uplink transmission configuration indication (UL TCI) state. With the configuration of the joint TCI state, the UE considers that different uplink and downlink channels and signals may have a guarantee of a good spatial filter symmetry, that is, communication is performed on the uplink and downlink by using a symmetric spatial filter pair. With the configuration of the separate DL TCI state, the UE transmits the downlink PDCCH (such as UE-specific (UE-specific)) and the PDSCH (such as UE-specific) by using the same spatial filter. In the configuration of the separate UL TCI state, the UE transmits the uplink PUCCH and the PUSCH by using the same spatial filter.

Currently, some communications systems (such as version 17 of the NR system) already support that, in a single-TRP scenario, the UE recovers different downlink (or uplink) channels or signals to a unified downlink (or uplink) spatial filter in a case in which a unified TCI state is configured and indicated. For example, in the case where the unified TCI state is configured and indicated, after a beam failure recovery acknowledgment, the UE may automatically recover different downlink channels (PDCCH or PDSCH, etc.) and signals (CSI-RS, etc.) to a unified downlink spatial filter. Similarly, the UE may automatically recover different uplink channels (PUCCH, PUSCH, etc.) and signals (sounding reference signal, SRS, etc.) to a unified uplink spatial filter. In addition, the UE may correspondingly adjust power control parameters of an uplink or downlink channel or signal to a new spatial filter.

However, it is not known how a terminal device that is configured and/or indicated with a unified TCI state performs beam failure recovery (BFR) in a multiple transmission reception point (multi-TRP) scenario.

To resolve one or more of the foregoing technical problems, this application proposes a communication method and a communications apparatus.

The method in this embodiment of this application is applicable to inter-cell or intra-cell multi-TRP automatic beam recovery. The following describes an intra-cell multi-TRP and an inter-cell multi-TRP with reference to FIG. 4.

As shown in FIG. 4, the TRP 410 and the TRP 420 are located in a same serving cell, and belong to intra-cell multi-TRP. In this case, the TRP 410 and the TRP 420 have a same physical cell identity (PCI) value (PCI #M), and the UE cannot distinguish between the TRP 410 and the TRP 420 by using the PCI. The TRP 410 and the TRP 430 are located in different serving cells, and belong to inter-cell multi-TRP. The TRP 410 and the TRP 430 have a same serving cell index, but have different PCI values (PCI #M and PCI #N). The UE may distinguish the two TRPs by performing PCI-related measurement.

In this embodiment of this application, intra-cell multi-TRP and inter-cell multi-TRP are not distinguished, unless otherwise specifically described.

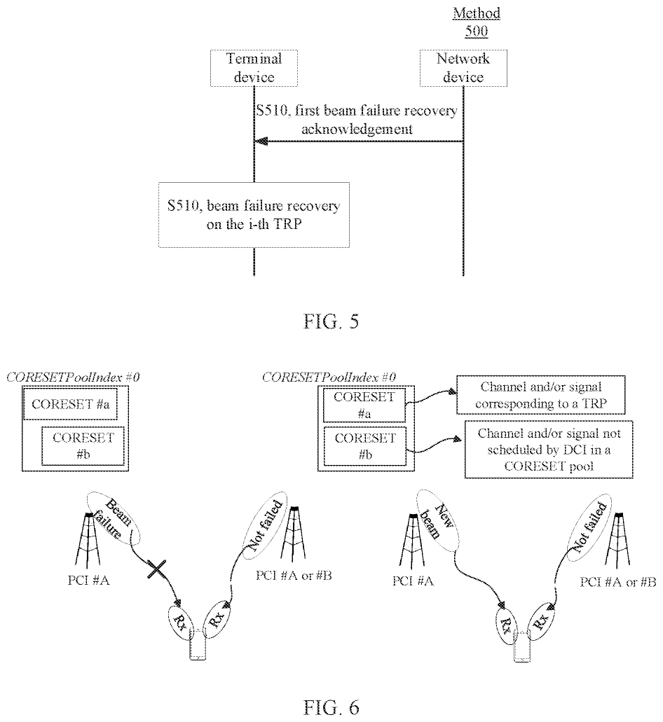

The following describes the embodiments of this application in detail with reference to FIG. 5 to FIG. 7.

FIG. 5 is a schematic flowchart of a communication method according to an embodiment of this application. The method 500 shown in FIG. 5 may include steps S510 and S520. Details are as follows.

S510. A terminal device receives a first beam failure recovery acknowledgement from a network device.

The terminal device may be configured and/or indicated with a unified TCI state. Optionally, the network device may configure a unified TCI state for the terminal device by using radio resource control (RRC) signaling. For example, when the terminal device switches to the RRC connected state, the network device may configure the unified TCI state to the terminal device by using RRC signaling. Optionally, the network device may indicate the unified TCI state to the terminal device by using a media access control control element (MAC CE) or downlink control information (DCI). For example, when the terminal device is in the RRC connected state, the network device may indicate the unified TCI state to the terminal device by using the MAC CE.

It should be noted that the network device may configure one or more TCI states (which may include a unified TCI state) for the terminal device. “Indication” in the foregoing embodiment may refer to that the terminal device uses a specific TCI state or activates a specific TCI state. For example, if only one TCI state is configured for the terminal device, the terminal device may be instructed to use the TCI state. If multiple TCI states are configured for the terminal device, the terminal device may be instructed to activate a specific TCI state. Certainly, in this embodiment of this application, the TCI state may be not configured but directly indicated with a TCI state. In this case, the TCI state may be configured while the TCI state is indicated.

The first beam failure recovery acknowledgement may be used to approve the beam failure recovery request for the i-th TRP of the M TRPs. M is a positive integer greater than or equal to 1, and i is a positive integer less than or equal to M.

For example, the first beam failure recovery acknowledgement may be an acknowledgement message sent by the network device to the terminal device in the third step in FIG. 2. The acknowledgment message may indicate that the TRP-specific beam failure recovery request of the terminal device is approved.

S520. The terminal device performs beam failure recovery on the i-th TRP.

Beam failure recovery for the i-th TRP herein may refer to recovering channels and/or signals corresponding to the i-th TRP to a same spatial filter.

The channel and/or the signal corresponding to the TRP may include a first signal and/or a first channel scheduled by using DCI in a physical downlink control channel (PDCCH) that is transmitted by using a resource in a control resource set (CORESET) corresponding to the TRP.

Optionally, the first signal includes an uplink signal and/or a downlink signal. For example, the first signal may include an access point-channel state information-reference signal (AP-CSI-RS) and/or an access point-sounding reference signal AP-SRS).

Optionally, the first channel may include an uplink channel and/or a downlink channel. For example, the first channel may include a physical downlink shared channel (PDSCH) and/or a physical uplink shared channel (PUSCH).

In this embodiment of this application, the terminal device may determine the first spatial filter based on a first index of an i-th CORESET group in the CORESET pool. Further, the terminal device may perform beam failure recovery to the first spatial filter on the i-th TRP.

The M TRPs may be corresponding to multiple DCI (multi-DCI, M-DCI), that is, each TRP in the M TRPs may send a respective DCI to schedule a terminal device. Optionally, the first index includes the CORESETPoolIndex of the i-th CORESET group.

The i-th CORESET group may be a CORESET groups that is configured by the network device for the terminal device and that is used by the terminal device to communicate with the i-th TRP. Optionally, the grouping of the CORESET may be configured in an explicit manner or an implicit manner. An explicit manner is described as an example. It is assumed that M is 2 (that is, there are totally two TRPs). The network device may configure an RRC parameter CORESETPoolIndex for each CORESET of the terminal device. The parameter CORESETPoolIndex may be used to divide the CORESET pool into two groups. For example, a CORESET whose CORESETPoolIndex value is 0 is grouped into the first group, a CORESET whose CORESETPoolIndex value is 1 is grouped into the second group, and each CORESET group is corresponding to a respective TRP. An implicit manner is described as an example. It is assumed that M is 2, and a default value of the RRC parameter CORESETPoolIndex corresponding to each CORESET may be different from one to another. For example, a default value of the RRC parameter CORESETPoolIndex corresponding to a CORESET is 0, and a default value of the RRC parameter CORESETPoolIndex corresponding to another CORESET is 1. In this case, the CORESET whose CORESETPoolIndex value is 0 is grouped into the first group, and the CORESET whose CORESETPoolIndex value is 1 is grouped into the second group.

The first spatial filter may be a spatial filter corresponding to a first RS corresponding to the i-th TRP (corresponding to the first index). The first RS herein may refer to a candidate reference signal (candidate RS) in the NBI RS Set. The first RS may be selected by the terminal device from the NBI RS Set, or may be configured or indicated by the network device. For example, the terminal device may determine, as the first spatial filter, a spatial filter corresponding to the first RS in the NBI RS Set corresponding to the first index (corresponding to the i-th TRP).

Optionally, the terminal device may recover the i-th CORESET group to the first spatial filter. Recovering the i-th CORESET group to the first spatial filter as described herein may be understood as: transmitting the i-th CORESET group by using the first spatial filter.

Optionally, the terminal device may recover, to the first spatial filter, the first signal and/or the first channel scheduled by the DCI in the i-th CORESET group. DCI in the i-th CORESET group may refer to DCI carried in the i-th CORESET group. The recovering of the first signal and/or the first channel scheduled by the DCI in the i-th CORESET group to the first spatial filter herein may be understood as: transmitting the first signal and/or the first channel by using the first spatial filter.

For example, for downlink, assuming that the CORESET pool is divided into two groups, the terminal device may recover a first CORESET group (for example, a PDCCH carried) to a spatial filter corresponding to a qnew0 selected from the NBI RS Set #0. The terminal device may recover the second CORESET group (for example, a PDCCH carried) to a spatial filter corresponding to a qnew1 selected from the NBI RS Set #1.

The terminal device may recover, to a spatial filter corresponding to the qnew0 selected from the NBI RS Set #0, the PDSCH and/or the AP-CSI-RS scheduled by the DCI in the first CORESET group (that is, the CORESETPoolIndex=0). The terminal device may recover, to a spatial filter corresponding to the qnew1 selected from the NBI RS Set #1, the PDSCH and/or the AP-CSI-RS scheduled by the DCI in the second CORESET group (that is, the CORESETPoolIndex=1).

For another example, for uplink, assuming that the CORESET pool is divided into two groups, the terminal device may recover, to the spatial filter corresponding to the qnew0 selected from the NBI RS Set #0, the PUSCH and/or the PUCCH and/or the AP-SRS scheduled by the DCI in the first CORESET group (that is, the CORESETPoolIndex=0). The terminal device may recover, to the spatial filter corresponding to the qnew1 selected from the NBI RS Set #1, the PUSCH and/or the PUCCH and/or the AP-SRS scheduled by the DCI in the second CORESET group (that is, the CORESETPoolIndex=1).

For signals (e.g., periodic or semi-persistent CSI-RS) and/or channels (e.g., semi-persistent PDSCH) not scheduled by DCI in the CORESET pool, the radio resource control (RRC) signaling may be used to configure whether to perform beam failure recovery on the channels and/or signals to a spatial filter corresponding to a TRP. For a periodic or semi-static CSI-RS, a granularity of the RRC configuration may be based on a CSI-RS resource set or a CSI-RS resource, that is, a CSI-RS resource set or a CSI-RS resource is recovered to a spatial filter corresponding to the TRP.

For example, the terminal device may receive first RRC signaling from the network device, and the first RRC signaling may be used to instruct to recover a second signal and/or a second channel to a second spatial filter. Further, the terminal device may recover the second signal and/or the second channel to the second spatial filter based on the first RRC signaling.

The second spatial filter may be determined based on a second index of a j-th CORESET group in the CORESET pool. The second signal may include a signal not scheduled by the DCI in the CORESET pool. The second channel may include a channel not scheduled by the DCI in the CORESET pool, and j is a positive integer less than or equal to M. Optionally, the second spatial filter may be the first spatial filter, that is, a spatial filter corresponding to the i-th TRP.

As shown in FIG. 6, a spatial filter failure occurs on a TRP in a serving cell PCI #A, and a CORESETPoolIndex=0 corresponds to the TRP. The terminal device may recover, to the first spatial filter corresponding to the TRP, a channel and/or a signal corresponding to the TRP. For signals and/or channels that is not scheduled by DCI in the CORESET pool, the first RRC signaling instructs to recover the first spatial filter, and the terminal device may also recover these channels and/or signals to the first spatial filter.

Optionally, in an example that the CORESET pool is divided into two groups, the RRC configuration may be implemented in the following manners.

### Manner 1:

Two RRC parameters may be set, that is, followFirstCORESETsBFR {enable, disable} and followSecondCORESETsBFR {enable, disable}, where followFirstCORESETsBFR corresponds to a first CORESET group, and followSecondCORESETsBFR corresponds to a second CORESET group, where ‘enable’ may represent performing beam failure recovery, and ‘disable’ may represent not performing beam failure recovery.

### Manner 2:

One RRC parameter followCORESETsBFR may be set, having values of {0,1,2}. ‘0’ may represent that beam failure recovery is not performed, ‘1’ may represent that beam failure recovery is performed based on a spatial filter corresponding to a first CORESET group, and ‘2’ may represent that beam failure recovery is performed based on a spatial filter corresponding to a second CORESET group.

### Manner 3:

One RRC parameter followCORESETsBFR may be set, having values of {0, 1,2,3}. ‘0’ may represent that beam failure recovery is not performed, ‘1’ may represent that beam failure recovery is performed based on the spatial filter corresponding to the first CORESET group, ‘2’ may represent that beam failure recovery is performed based on the spatial filter corresponding to the second CORESET group, and‘3’ may represent that beam failure recovery is performed based on both the spatial filter corresponding to the first CORESET group and the spatial filter corresponding to the second CORESET group.

The terminal device may not perform beam failure recovery on signals and/or channels that are not scheduled by DCI in the CORESET pool and not configured with beam failure recovery by RRC signaling.

For example, the terminal device may not perform beam failure recovery on a third signal and/or a third channel. The third signal may be a signal not scheduled by the DCI in the CORESET pool, and a third channel may be a channel not scheduled by the DCI in the CORESET pool.

In this embodiment of this application, when M TRPs using single DCI (S-DCI) for scheduling, only one of the M TRPs sends DCI to the terminal device to schedule a signal and/or a channel from the M TRPs. In this case, there is no RRC parameter CORESETPoolIndex, and the M TRPs are located in a same serving cell, and the terminal device cannot distinguish between transmissions of the M TRPs according to the CORESETPoolIndex or the PCI.

Optionally, the network device may divide the CORESET pool into multiple groups by using RRC signaling (for example, RRC signaling may introduce an RRC parameter similar to CORESETPoolIndex).

For example, the terminal device may receive second RRC signaling. The second RRC signaling may be used to indicate CORESETs included in the i-th CORESET group and the first index of the i-th CORESET group in the CORESET pool.

In this case, in a case in which the CORESET pool is divided into multiple groups, beam failure recovery may be performed on the M TRPs with reference to the method in the foregoing embodiment.

Optionally, in addition to the foregoing solution of grouping the CORESETs, search space sets (SSS) of a downlink control channel may be grouped by using RRC signaling. In this way, the terminal device may perform, according to the grouping of the search space sets, the TRP-specific beam failure recovery by using the associated CORESET. Different search space set groups may be respectively corresponding to different search periods and offsets.

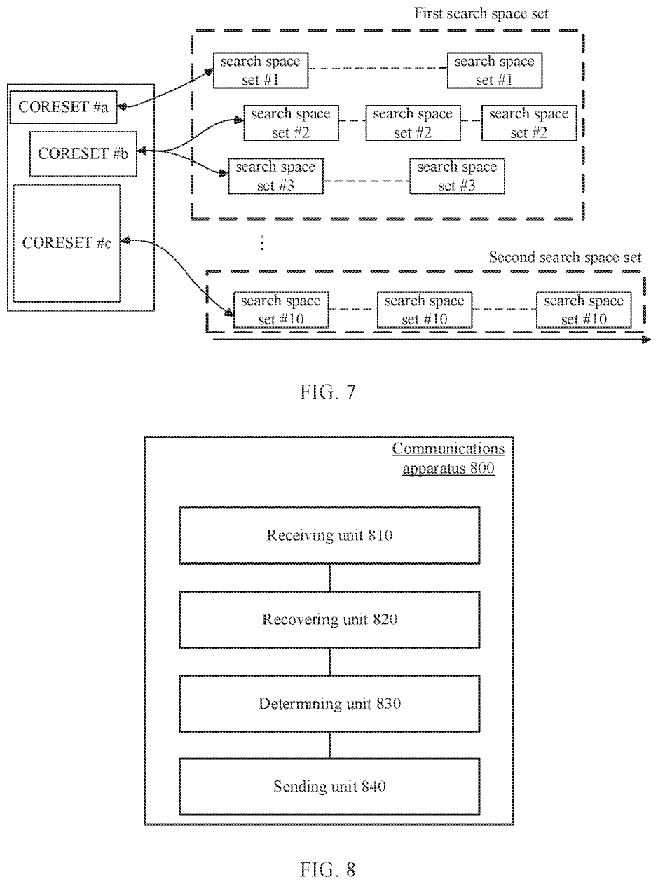

Optionally, each search space set group may be associated with a CORESET. A bandwidth part (BWP) may have a maximum of 10 search space set groups, and a maximum of three CORESET groups. Therefore, this association may be many-to-one. When configuring resources, the network device may ensure that a same search space set group is not associated with two CORESET groups, and the two CORESET groups are respectively corresponding to different TRPs. For example, as shown in FIG. 7, CORESET #a may be corresponding to search space set #1, CORESET #b may be corresponding to search space set #2 and search space set #3, and CORESET #c may be corresponding to search space set #10. The first search space set group may include search space set #1, search space set #2, and search space set #3, and the second search space set group includes search space set #10.

It can be seen from the RRC segment how a search space set is associated with a CORESET. For example, in the following RRC segment, “SearchSpaceId” represents the index of the search space set, and “ControlResourceSetId” represents the index of the CORESET associated with the search space set.

| | |
|---|---|
| Search Space ::= | SEQUENCE { |
| searchSpaceId | SearchSpaceId, |
| controlResourceSetId | ControlResourceSetId |

OPTIONAL, -- Cond SetupOnly

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}

For example, the terminal device may receive third radio resource control RRC signaling, and the third RRC signaling may be used to indicate the search space set included in an i-th search space set group and an index of the i-th search space set group in a search space set pool. Further, the terminal device may determine the index of the i-th search space set group in the search space set pool as a first index of the i-th CORESET group in the CORESET pool. The i-th CORESET group may include a CORESET associated with the search space set in the i-th search space set group.

In this case, in a case in which the search space set pool is divided into multiple groups, beam failure recovery may be performed on the M TRPs with reference to the method in the foregoing embodiment.

For example, for downlink, assuming that the search space set pool is divided into two groups, the terminal device may recover all CORESETs (for example, PDCCH carried) associated with a first search space set group to a spatial filter corresponding to the qnew0 selected from the NBI RS Set #0. The terminal device may recover all CORESETs (for example, PDCCH carried) associated with a second search space set group to a spatial filter corresponding to the qnew1 selected from the NBI RS Set #1.

The terminal device may recover, to a spatial filter corresponding to the qnew0 selected from the NBI RS Set #0, PDSCHs and/or AP-CSI-RSs scheduled by DCIs in all the CORESETs associated with the first search space set group. The terminal device may recover, to the spatial filter corresponding to the qnew1 selected from the NBI RS Set #1, PDSCHs and/or AP-CSI-RSs scheduled by DCIs in all the CORESETs associated with the second search space set group.

For another example, for uplink, assuming that all the CORESETs associated with the search space set pool is divided into two groups, the terminal device may recover, to the spatial filter corresponding to the qnew0 selected from the NBI RS Set #0, PUSCHs and/or PUCCHs and/or AP-SRSs scheduled by DCIs in all the CORESETs associated with the first search space set group. The terminal device may recover, to the spatial filter corresponding to the qnew1 selected from the NBI RS Set #1, PUSCHs and/or PUCCHs and/or AP-SRSs that are scheduled by DCIs in all the CORESETs associated with the second search space set group.

For signals (e.g., Periodic or semi-persistent CSI-RS) and/or channels (e.g., semi-persistent PDSCH) not scheduled by DCI in any CORESET associated with the search space set pool, RRC signaling may be used to configure whether to perform beam failure recovery on the channels and/or signals to a spatial filter corresponding to a TRP.

For signals and/or channels that are not scheduled by DCI in any CORESET associated with the search space set pool and a recovery by RRC signaling, the terminal device may not perform beam failure recovery.

The advantage of this way lies in that, by the RRC configuration based on the search space set, the granularity of beam failure recovery can be finer than that based on the CORESET groups. In addition, adjustment may be performed according to a type of the search space set. For example, the search space set for BFR and the search space set for paging can be independently controlled, so that beam failures of the search space sets can be recovered to specific TRPs, thereby reducing a delay of specific control information.

In some embodiments of this application, a TRP-specific beam failure recovery solution may be specified in a communications protocol in advance, so that no RRC signaling is needed for configuration, thereby improving beam failure recovery efficiency. In addition, it is unnecessary to distinguish between the M-DCI-based multi-TRP operations and S-DCI-based multi-TRP operations, because the method is applicable to both, which is convenient to implement. Optionally, the grouping of CORESETs may be preset in a communications protocol.

For example, target configuration information may be set in the terminal device based on a communications protocol, and the target configuration information may include: a target CORESET that is used by the terminal device to communicate with an i-th TRP is recovered to a spatial filter corresponding to a target RS.

In this case, the terminal device may recover, according to the target configuration information, the target CORESET to the spatial filter corresponding to the target RS.

Optionally, the grouping of search space sets may be preset in the communications protocol.

For example, target configuration information may be set in the terminal device based on a communications protocol, and the target configuration information may include: a CORESET associated with the target search space set is recovered to a spatial filter corresponding to a target RS.

In this case, the terminal device may recover, according to the target configuration information, the target CORESET to the spatial filter corresponding to the target RS. The target CORESET may include a CORESET that is in CORESETs associated with the target search space set and that is used for communication between the terminal device and the i-th TRP.

Further, the terminal device may further recover, according to the target configuration information, a target signal and/or a target channel scheduled by a DCI on a target CORESET to a spatial filter corresponding to a target RS.

Optionally, the target signal may include an AP-CSI-RS.

Optionally, the target channel may include a PDSCH and/or PUSCH.

For a specific beam failure recovery method, reference can be made to the foregoing embodiments. Details are not described herein again.

In an embodiment of this application, the terminal device may report, to the network device, an RS identifier corresponding to a TRP on which beam failure occurs. Correspondingly, the network device instructs the terminal device to recover the TRP to the spatial filter corresponding to the RS.

Optionally, the terminal device may send a beam failure recovery request to the network device, where the beam failure recovery request may carry first information, and the first information may be used to indicate the target RS. The beam failure recovery request may be a BFRQ reported by the terminal device to the network device in the second step of FIG. 2, that is, the terminal device may send the beam failure recovery request to the network device before S510.

Further, the network device may send a target unified TCI state to the terminal device, or in other words, the network device may indicate, to the terminal device, a target unified TCI state associated with the target RS. For example, the network device may send the target unified TCI state to the terminal device by using the MAC CE. The target unified TCI state may be associated with the target RS. Optionally, the association relationship between the target unified TCI state and the target RS may be configured when the network device configures the unified TCI state for the terminal device. One or more TCI states configured by the network device for the terminal device may include the target unified TCI state.

Alternatively, because the network device knows an association relationship between the target unified TCI state and the target RS, after receiving the first information, the network device may not send the target unified TCI state, but send only acknowledgement information to the terminal device. For example, the network device may send acknowledgement information to the terminal device, where the acknowledgement information may be used to indicate whether the network device approves beam failure recovery on a signal and/or a channel under a target unified TCI state.

Optionally, when the target unified TCI state is in an active state, the terminal device may recover an i-th TRP to the spatial filter corresponding to the target RS.

For example, the target unified TCI state may be a joint TCI state. In this case, the terminal device may recover, to the spatial filter corresponding to the target RS, at least one of an uplink channel, an uplink signal, a downlink channel, and a downlink signal under the joint TCI state.

For another example, the target unified TCI state may be a DL TCI state. In this case, the terminal device may recover, to the spatial filter corresponding to the target RS, a downlink channel and/or a downlink signal under the DL TCI state.

For another example, the target unified TCI state may be a UL TCI state. In this case, the terminal device may recover, to the spatial filter corresponding to the target RS, a uplink channel and/or a uplink signal under the UL TCI state.

In the foregoing embodiment, the downlink channel may include a PDCCH and/or a PDSCH. The downlink signal may include an AP-CSI-RS. The uplink channel may include a PUCCH and/or a PUSCH. The downlink signal may include an SRS.

In this embodiment of this application, a terminal device that is configured and/or indicated with a unified TCI state receives a first beam failure recovery acknowledgement, and performs beam failure recovery on an i-th TRP of the M TRPs, thereby implementing multi-TRP beam failure recovery.

The foregoing describes the method embodiments of this application in detail with reference to FIG. 1 to FIG. 7. The following describes the apparatus embodiments of this application in detail with reference to FIG. 8 and FIG. 10. It should be understood that the description of the method embodiments corresponds to the description of the apparatus embodiments, and therefore, for parts that are not described in detail, reference may be made to the foregoing method embodiments.

FIG. 8 is a schematic structural diagram of a communications apparatus according to an embodiment of this application. As shown in FIG. 8, the apparatus 800 includes a receiving unit 810 and a recovering unit 820, which are specifically as follows.

The receiving unit 810 is configured to receive a first beam failure recovery acknowledgement from a network device, where the first beam failure recovery acknowledgement is used to approve a beam failure recovery request for an i-th transmission reception point TRP of M TRPs, the apparatus is configured and/or indicated with a unified transmission configuration indication (TCI) state, M is a positive integer greater than 1, and i is a positive integer less than or equal to M.

The recovering unit 820 is configured to perform beam failure recovery on the i-th TRP.

Optionally, the recovering unit 820 is specifically configured to determine a first spatial filter based on a first index of an i-th control channel resource set CORESET group in a CORESET pool, where the i-th CORESET group includes a CORESET that is configured by the network device for the apparatus and that is used for communication between the apparatus and the i-th TRP; and performing beam failure recovery to the first spatial filter on the i-th TRP.

Optionally, the recovering unit 820 is specifically configured to determine a spatial filter corresponding to a first reference signal RS in a new beam discovery reference signal set NBI RS Set corresponding to the first index as the first spatial filter.

Optionally, the recovering unit 820 is specifically configured to recover the i-th CORESET group to the first spatial filter.

Optionally, the recovering unit 820 is specifically configured to recover a first signal and/or a first channel scheduled by downlink control information DCI in the i-th CORESET group to the first spatial filter.

Optionally, the first channel includes an uplink channel and/or a downlink channel, and the first signal includes an uplink signal and/or a downlink signal.

Optionally, the first signal includes an access point-channel state information-reference signal AP-CSI-RS.

Optionally, the first channel includes a physical downlink shared channel PDSCH and/or a physical uplink shared channel PUSCH.

Optionally, the recovering unit 820 is further configured to receive first radio resource control RRC signaling from a network device, where the first RRC signaling is used to instruct to recover a second signal and/or a second channel to a second spatial filter, the second spatial filter is determined based on a second index of a j-th CORESET group in the CORESET pool, the second signal includes a signal not scheduled by downlink control information DCI in the CORESET pool, the second channel includes a channel not scheduled by the DCI in the CORESET pool, and j is a positive integer less than or equal to M; and recover the second signal and/or the second channel to the second spatial filter based on the first RRC signaling.

Optionally, the recovering unit 820 is further configured to: skip performing beam failure recovery on a third signal and/or a third channel, where the third signal is a signal not scheduled by downlink control information DCI in the CORESET pool, and the third channel is a channel not scheduled by the DCI in the CORESET pool.

Optionally, the M TRPs are corresponding to multi-downlink control information M-DCI, and the first index includes a CORESETPoolIndex of the i-th CORESET group.

Optionally, the M TRPs are corresponding to single downlink control information S-DCI, and the receiving unit 810 is further configured to receive second radio resource control RRC signaling, where the second RRC signaling is used to indicate a CORESET included in the i-th CORESET group and the first index of the i-th CORESET group in the CORESET pool.

Optionally, the M TRPs are corresponding to single downlink control information S-DCI, and the receiving unit 810 is further configured to receive third radio resource control RRC signaling, where the third RRC signaling is used to indicate a search space set included in an i-th search space set group and an index of the i-th search space set group in a search space set pool. The apparatus 800 further includes a determining unit 830, configured to determine the index of the i-th search space set group in the search space set pool as the first index of the i-th control channel resource set CORESET group in the CORESET pool, where the i-th CORESET group comprises a CORESET associated with a search space set in the i-th search space set group.

Optionally, in the apparatus, target configuration information is configured based on a communications protocol, and the target configuration information includes: a target control channel resource set CORESET used for communication between the apparatus and the i-th TRP is recovered to a spatial filter corresponding to a target reference signal RS. The recovering unit 820 is specifically configured to recover, according to the target configuration information, the target CORESET to the spatial filter corresponding to the target RS.

Optionally, in the apparatus, target configuration information is configured based on a communications protocol, and the target configuration information includes: the target configuration information comprises: a control channel resource set CORESET associated with a target search space set is recovered to a spatial filter corresponding to a target reference signal RS. The recovering unit 820 is specifically configured to recover, according to the target configuration information, a target CORESET to the spatial filter corresponding to the target RS, where the target CORESET includes a CORESET associated with the target search space set and that is used for communication between the apparatus and the i-th TRP.

Optionally, the recovering unit 820 is specifically configured to recover, according to the target configuration information, a target signal and/or a target channel scheduled by downlink control information DCI on the target CORESET to the spatial filter corresponding to the target RS.

Optionally, the target signal includes an access point-channel state information-reference signal AP-CSI-RS.

Optionally, the target channel includes a physical downlink shared channel PDSCH.

Optionally, the apparatus 800 further includes a sending unit 840, configured to send a beam failure recovery request to the network device, where the beam failure recovery request carries first information, and the first information is used to indicate a target reference signal RS. The receiving unit 810 is further configured to receive a target unified TCI state sent by the network device, where the target unified TCI state is associated with the target RS.

Optionally, the recovering unit 820 is specifically configured to: when the target unified TCI state is in an active state, recover the i-th TRP to a spatial filter corresponding to the target reference signal RS.

Optionally, the target unified TCI state includes a joint transmission configuration indication (joint TCI) state. The recovering unit 820 is specifically configured to recover, to the spatial filter corresponding to the target RS, at least one of an uplink channel, an uplink signal, a downlink channel, and a downlink signal under the joint TCI state.

Optionally, the target unified TCI state includes a downlink transmission configuration indication DL TCI state. The recovering unit 820 is specifically configured to recover, to the spatial filter corresponding to the target RS, a downlink channel and/or a downlink signal under the DL TCI state.

Optionally, the target unified TCI state includes an uplink transmission configuration indication UL TCI state. The recovering unit 820 is specifically configured to recover, to the spatial filter corresponding to the target RS, an uplink channel and/or an uplink signal under the UL TCI state.

Optionally, the downlink channel includes a physical downlink control channel PDCCH and/or a physical downlink shared channel PDSCH, and the downlink signal includes an access point-channel state information-reference signal AP-CSI-RS.

Optionally, the uplink channel includes a physical uplink control channel PUCCH and/or a physical uplink shared channel PUSCH, and the downlink signal includes a sounding reference signal SRS.

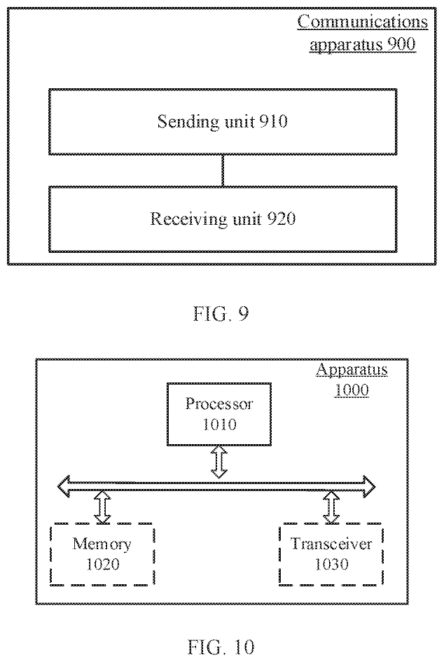

FIG. 9 is a schematic structural diagram of a communications apparatus according to an embodiment of this application. As shown in FIG. 9, the apparatus 900 includes a sending unit 910, which is specifically as follows.

The sending unit 910 is configured to send a first beam failure recovery acknowledgement to a terminal device, where the first beam failure recovery acknowledgement is used to approve a beam failure recovery request for an i-th transmission reception point TRP of M TRPs, the terminal device is configured and/or indicated with a unified transmission configuration indication (TCI) state, M is a positive integer greater than or equal to 1, and i is a positive integer less than or equal to M.

Optionally, the sending unit 910 is further configured to send first radio resource control RRC signaling to the terminal device, where the first RRC signaling is used to instruct to recover a second signal and/or a second channel to a second spatial filter, the second spatial filter is determined based on a second index of a j-th control channel resource set CORESET group in a CORESET pool, the second signal includes a signal not scheduled by downlink control information DCI in the CORESET pool, the second channel includes a channel not scheduled by the DCI in the CORESET pool, and j is a positive integer less than or equal to M.

Optionally, the M TRPs are corresponding to multi-downlink control information M-DCI.

Optionally, the M TRPs are corresponding to single downlink control information S-DCI, the sending unit 910 is further configured to send second radio resource control RRC signaling to the terminal device, where the second RRC signaling is used to indicate a CORESET included in an i-th CORESET group and a first index of the i-th CORESET group in a CORESET pool.

Optionally, the M TRPs are corresponding to single downlink control information S-DCI, and the sending unit is further configured to send third radio resource control RRC signaling to the terminal device, where the third RRC signaling is used to indicate a search space set comprised in an i-th search space set group and an index of the i-th search space set group in a search space set pool.

Optionally, the apparatus 900 further includes a receiving unit 920, configured to receive a beam failure recovery request sent by the terminal device, where the beam failure recovery request carries first information, and the first information is used to indicate a target reference signal RS. The sending unit 910 is further configured to send a target unified TCI state to the terminal device, where the target unified TCI state is associated with the target RS.

Optionally, the target unified TCI state includes one or more of a joint transmission configuration indication (joint TCI) state, a downlink transmission configuration indication DL TCI state, and an uplink transmission configuration indication UL TCI state.

Optionally, a downlink channel under the joint TCI state and/or the DL TCI state includes a physical downlink control channel PDCCH and/or a physical downlink shared channel PDSCH, and the downlink signal includes an access point-channel state information-reference signal AP-CSI-RS.

Optionally, an uplink channel under the joint TCI state and/or the UL TCI state includes a physical uplink control channel PUCCH and/or a physical uplink shared channel PUSCH, and the downlink signal includes a sounding reference signal SRS.

FIG. 10 is a schematic structural diagram of an apparatus according to an embodiment of this application. A dashed line in FIG. 10 indicates that a unit or module is optional. The apparatus 1000 may be configured to implement the method described in the foregoing method embodiments. The apparatus 1000 may be a chip or a communications apparatus.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program. The program may be executed by the processor 1010, to cause the processor 1010 to perform the methods described in the foregoing method embodiments. The memory 1020 may be independent of the processor 1010 or may be integrated into the processor 1010.

The apparatus 1000 may further include a transceiver 1030. The processor 1010 may communicate with another device or chip by using the transceiver 1030. For example, the processor 1010 may transmit and receive data to and from another device or chip through the transceiver 1030.

An embodiment of the application further provides a computer-readable storage medium for storing a program. The computer-readable storage medium may be applied to any one of communications apparatus provided in embodiments of this application, and the program causes a computer to execute the method executed by the communications apparatus in any one of embodiments of this application.

An embodiment of the application further provides a computer program product. The computer program product includes a program. The computer program product may be applied to a communications apparatus provided in any one of embodiments of this application, and the program causes a computer to execute the methods executed by the communications apparatus in any one of embodiments of this application.

An embodiment of the application further provides a computer program. The computer program may be applied to a communications apparatus provided in any one of embodiments of this application, and the computer program causes a computer to execute the methods executed by the communications apparatus in any one of embodiments of this application.

It should be understood that, in embodiments of this application, “B corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” describes merely an association relationship of associated objects, and represents that there may be three relationships. For example, A and/or B may represent three cases: only A exists, both A and B exist, and only B exists. In addition, the character “/” herein generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of embodiments of this application.

In several embodiments provided in the application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual requirements to achieve the objectives of the solutions of embodiments.

In addition, functional units in embodiments of the application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing describes merely some specific implementations of the application, but the protection scope of the application is not limited thereto. Any variation or replacement readily figured out by a person skilled in the art within the technical scope disclosed in the application shall fall within the protection scope of the application. Therefore, the protection scope of the application shall be subject to the protection scope of the claims.

What is claimed is:

1. A terminal device, comprising a processor configured to perform operations of:
receiving a first beam failure recovery acknowledgement from a network device, wherein the first beam failure recovery acknowledgement is used to approve a beam failure recovery request for an i-th transmission reception point (TRP) of M TRPs, the terminal device is configured and/or indicated with a unified transmission configuration indication (TCI) state, M is a positive integer greater than or equal to 1, and i is a positive integer less than or equal to M; and
performing beam failure recovery on the i-th TRP.

2. The terminal device according to claim 1, wherein the processor is configured to perform operations of:
determining a spatial filter based on a first index of an i-th control channel resource set (CORESET) group in a CORESET pool, wherein the i-th CORESET group includes a CORESET that is configured by the network device for the terminal device and that is used for communication between the terminal device and the i-th TRP; and
performing beam failure recovery to the first spatial filter on the i-th TRP.

3. The terminal device according to claim 2, wherein the processor is configured to perform an operation of:
determining a spatial filter corresponding to a first reference signal (RS) in a new beam discovery reference signal set (NBI RS Set) corresponding to the first index as the first spatial filter.

4. The terminal device according to claim 2, wherein the processor is configured to perform an operation of:
recovering the i-th CORESET group to the first spatial filter.

5. The terminal device according to claim 4, wherein the processor is configured to perform an operation of:
recovering a first signal and/or a first channel scheduled by downlink control information (DCI) in the i-th CORESET group to the first spatial filter.

6. The terminal device according to claim 5, wherein the first channel comprises an uplink channel and/or a downlink channel, and the first signal comprises an uplink signal and/or a downlink signal.

7. The terminal device according to claim 6, wherein the first signal comprises an access point-channel state information-reference signal (AP-CSI-RS).

8. The terminal device according to claim 6, wherein the first channel comprises a physical downlink shared channel (PDSCH) and/or a physical uplink shared channel (PUSCH).

9. The terminal device according to claim 2, wherein the processor is configured to perform operations of:
receiving first radio resource control (RRC) signaling from the network device, wherein the first RRC signaling is used to instruct to recover a second signal and/or a second channel to a second spatial filter, the second spatial filter is determined based on a second index of a j-th CORESET group in the CORESET pool, the second signal comprises a signal not scheduled by downlink control information (DCI) in the CORESET pool, the second channel comprises a channel not scheduled by the DCI in the CORESET pool, where j is a positive integer less than or equal to M; and
recovering the second signal and/or the second channel to the second spatial filter based on the first RRC signaling.

10. The terminal device according to claim 2, wherein the M TRPs are corresponding to multi-downlink control information (M-DCI), and the first index comprises a CORESETPoolIndex of the i-th CORESET group.

11. The terminal device according to claim 2, wherein the M TRPs are corresponding to single downlink control information (S-DCI), and the processor is configured to perform an operation of:
receiving second radio resource control (RRC) signaling, wherein the second RRC signaling is used to indicate a CORESET comprised in the i-th CORESET group and the first index of the i-th CORESET group in the CORESET pool.

12. The terminal device according to claim 1, wherein target configuration information is configured in the terminal device based on a communications protocol, and the target configuration information comprises: a target control channel resource set (CORESET) that is used by the terminal device to communicate with the i-th TRP is recovered to a spatial filter corresponding to a target reference signal (RS); and
the processor is configured to perform an operation of:
recovering the target CORESET to the spatial filter corresponding to the target RS according to the target configuration information.

13. The terminal device according to claim 12, wherein the processor is configured to perform an operation of:
recovering, according to the target configuration information, a target signal and/or a target channel scheduled by downlink control information (DCI) on the target CORESET to the spatial filter corresponding to the target RS.

14. A network device, comprising a processor configured to perform an operation of:
sending a first beam failure recovery acknowledgement to a terminal device, where the first beam failure recovery acknowledgement is used to approve a beam failure recovery request for an i-th transmission reception point (TRP) of M TRPs, the terminal device is configured and/or indicated with a unified transmission configuration indication (TCI) state, M is a positive integer greater than or equal to 1, and i is a positive integer less than or equal to M.

15. The network device according to claim 14, wherein the processor is configured to perform an operation of:
sending first radio resource control (RRC) signaling to the terminal device, wherein the first RRC signaling is used to instruct to recover a second signal and/or a second channel to a second spatial filter, the second spatial filter is determined based on a second index of a j-th control channel resource set (CORESET) group in a CORESET pool, the second signal comprises a signal not scheduled by downlink control information (DCI) in the CORESET pool, the second channel comprises a channel not scheduled by the DCI in the CORESET pool, where j is a positive integer less than or equal to M.

16. The network device according to claim 14, wherein the M TRPs are corresponding to multi-downlink control information (M-DCI).

17. The network device according to claim 14, wherein the M TRPs are corresponding to single downlink control information (S-DCI), and the processor is configured to perform an operation of:
sending second radio resource control (RRC) signaling to the terminal device, wherein the second RRC signaling is used to indicate a CORESET comprised in an i-th CORESET group and a first index of the i-th CORESET group in a CORESET pool.

18. A communication method, comprising:
receiving, by a terminal device, a first beam failure recovery acknowledgement from a network device, wherein the first beam failure recovery acknowledgement is used to approve a beam failure recovery request for an i-th transmission reception point (TRP) of M TRPs, the terminal device is configured and/or indicated with a unified transmission configuration indication (TCI) state, M is a positive integer greater than or equal to 1, and i is a positive integer less than or equal to M; and
performing, by the terminal device, beam failure recovery on the i-th TRP.

19. The method according to claim 18, wherein the performing, by the terminal device, beam failure recovery on the i-th TRP comprises:
determining, by the terminal device, a spatial filter based on a first index of an i-th control channel resource set (CORESET) group in a CORESET pool, wherein the i-th CORESET group includes a CORESET that is configured by the network device for the terminal device and that is used for communication between the terminal device and the i-th TRP; and
performing, by the terminal device, beam failure recovery to the first spatial filter on the i-th TRP.

20. The method according to claim 19, wherein the determining, by the terminal device, a first spatial filter based on a first index of an i-th CORESET group in a CORESET pool comprises:
determining, by the terminal device, a spatial filter corresponding to a first reference signal (RS) in a new beam discovery reference signal set (NBI RS Set) corresponding to the first index as the first spatial filter.
